(19) United States
(12) Patent Application Publication
(10) Pub. No.: US 2026/0187150 A1
(43) Pub. Date: Jul. 2, 2026

(54) OFFLINE GRAPH BATCH PROCESSING

(71) Applicant: PayPal, Inc., San Jose, CA (US)

(72) Inventors: Zhanghao Hu, San Jose, CA (US); Naresh Kumar Dintakurthi, Lathrop, CA (US); Zhe Huang, Shanghai (CN); Yangxing Liu, Shanghai (CN); Ziyao Chen, San Jose, CA (US); Jiadi Xiong, San Jose, CA (US)

(21) Appl. No.: 19/062,749

(22) Filed: Feb. 25, 2025

(30) Foreign Application Priority Data
Dec. 30, 2024 (WO) PCT/CN2024/143711

(51) Int. Cl. G06F 16/901; G06F 16/245; G06F 16/27

(52) U.S. Cl. CPC G06F 16/9024; G06F 16/245; G06F 16/27

(57) ABSTRACT

Techniques are disclosed for a computer system performing batch processing on graph data using an offline mirrored graph database store synchronized from an online graph database store. The computer system includes a user service that receives a batch processing request and submits a batch job creation request. A batch processing service triggers the batch job based on the request and coordinates execution. A graph execution engine retrieves input data, initiates a query to the offline mirrored graph database store, and performs computations on the retrieved graph data to generate a result set. The result set is stored in a cloud storage system for retrieval by downstream systems or services. The offline graph database enables complex graph computations, including multi-hop traversals and graph variable calculations, with relaxed latency requirements compared to the online graph database.

### PRIORITY CLAIM

The present application claims priority to PCT Appl. No. PCT/CN2024/143711, entitled “OFFLINE GRAPH BATCH PROCESSING”, filed Dec. 30, 2024, which is incorporated by reference herein in its entirety.

### BACKGROUND

### Technical Field

This disclosure relates generally to graph databases and, more specifically, to offline usage of graph databases.

### Description of the Related Art

Many software services, including those with large numbers of user accounts, consume a large volume of transaction data every day. Using machine learning solutions in such settings has traditionally relied on tabular data, which is less effective at capturing sophisticated relationships between accounts, especially within larger groups of accounts. For this reason the use of a particular type of storage format known as graph databases may be favored in these settings. Graph-based solutions, with their natural ability to connect accounts using different types of relationships, and their capability to perform message passing and aggregation through advanced graph algorithms, can handle complex variable calculations in a more scalable way. For example, one type of complex computational problem—referred to in the art as NP-hard—can be naturally modeled as graph problems. Graph-based solutions thus show great promise for identifying even more complex patterns.

The structure of a graph database is fundamentally different from that of traditional relational databases. Graph databases commonly have three primary components: nodes, edges, and properties. Nodes are the fundamental units of a graph database that represent entities or objects. Each node can hold properties, which may be key-value pairs that provide additional information about the entity/object. For example, in a social network graph, each user might be represented as a node with properties such as name, age, and location. Edges are the connections between nodes, representing the relationships or interactions between them. Like nodes, edges can also have properties that describe the nature of the relationship. For instance, in the same social network, an edge might represent a friendship between two users, with properties indicating the date the friendship was established. Accordingly, both nodes and edges can have properties, which are attributes that store metadata. Such properties allow for richer data representation and enable more complex querying. For example, a friendship edge might have a property such as “strength” to indicate the closeness of the relationship.

This graph structure enables graph databases to efficiently handle complex queries involving traversals and relationships, making them ideal for applications where connections and interactions are crucial, such as social networks, recommendation systems, and fraud detection. Accordingly, graph databases are increasingly being utilized in computer decision-making processes due to their ability to efficiently model and analyze complex relationships within large datasets. Unlike traditional relational databases that rely on structured tables, the nodes, edges, and properties of graph databases allow for a more intuitive representation of interconnected information. This structure enables advanced querying capabilities that can uncover patterns and insights that might be invisible in other database formats. Their inherent flexibility also allows organizations to adapt to evolving data structures, making them a powerful tool for dynamic environments where relationships are key to understanding and predicting outcomes.

Data scientists are frequently interested in particular portions of a graph database or relationships within the graph database, which can be referred to using graph variables that represent nodes and edges within a graph query. Once a graph variable is assigned to a node or edge, its properties can be accessed within the query using the graph variable name.

### BRIEF DESCRIPTION OF THE DRAWINGS

FIGS. 1A-B are block diagrams of embodiments of a computer system for performing batch processing using an offline mirrored graph database.

FIG. 2 is a block diagram of one embodiment of a user service within a computer system for graph database processing.

FIG. 3 is a block diagram of one embodiment of a batch processing service within a computer system for graph database processing.

FIG. 4 is a block diagram of one embodiment of a graph execution engine.

FIG. 5 is a sequence diagram of one embodiment of processing of a batch processing request.

FIG. 6 is a diagram of one embodiment of a graph variable development and production lifecycle.

FIG. 7 is a diagram of one embodiment of a graph-based detection of circular money movement.

FIG. 8A-B are flow diagrams of embodiments of methods for performing batch processing using an offline mirrored graph database.

FIG. 9 is a block diagram of one embodiment of a computer system usable to implement a batch processing system.

### DETAILED DESCRIPTION

Graph databases may be employed in both real-time (i.e., online) and asynchronous (i.e., offline) contexts, where the data and computational requirements can vary significantly. Real-time graph processing systems may utilize graph databases for scenarios requiring immediate responses, such as fraud detection during online transactions or real-time e-commerce recommendations. These systems may prioritize low-latency queries and rely on live, continuously updated graph data for accurate and timely results. Real-time graph-processing systems may be limited, however, in the complexity of the computations they can perform due to stringent latency requirements and computational constraints.

For purposes of this disclosure, an online graph database has a set of performance requirements that the permissible latency for a graph query is somewhere under 2 seconds—for example, under 2 seconds, under 1 second, under 500 ms, under 400 ms, under 200 ms, under 100 ms, under 50 ms, and so on, down into the microsecond range. An online graph database thus has a real-time performance standard. In contrast, an offline graph database has a permissible latency for a graph query that does not meet a real-time performance standard (i.e., with permissible graph latencies over 2 seconds), and is thus a non-real-time performance standard. In many cases, offline graph databases have much longer permissible latencies—for example, up to 10 seconds, up to 15 seconds, up to 20 seconds, up to 25 seconds, up to 30 seconds, and so on. Note that offline graph databases can of course have graph queries that complete well below the maximum permitted latency. In one particular implementation, an offline graph database may have a first set of performance requirements specifying that graph query latency is less than 30 seconds, in contrast to an online graph database that the offline graph database is mirrored from, which has a second set of performance requirements specifying that graph query latency is less than 100 ms, meaning 100 ms is the maximum permitted latency to complete a graph query without timing out.

In contrast, asynchronous or offline graph processing systems may be utilized for more computationally intensive tasks, such as identifying multi-hop relationships, performing cycle detection, or analyzing historical trends. These systems may operate without strict time constraints, allowing for deeper and more complex analysis. Offline graph processing can involve batch processing of large datasets and may require significant computational resources to construct graphs from tabular or raw data before performing analyses. This duality of real-time and offline graph processing highlights the challenges of balancing computational efficiency, data consistency, and integration flexibility across different use cases.

Existing offline graph processing solutions face significant limitations. In traditional systems, offline graph computations are constructed from large tables, requiring substantial resources to build the graph structure and perform computations. This process is computationally intensive and time-consuming, especially for large datasets, and it limits the ability to efficiently perform complex queries (e.g., such as multi-hop traversals or cycle detections). Offline solutions, on the other hand, can lack real-time data synchronization with online graph stores. This limitation may hinder the ability to utilize up-to-date information for batch processing, which may be essential for applications that rely on accurate, near real-time data.

Within enterprise software environments, graph variables are highly valuable and extensively utilized in developing artificial intelligence (AI) and machine learning (ML) solutions across various domains, including risk management, compliance, and credit. But using graph variables in offline AI/ML solutions in a simple and cost-effective way remains a significant challenge. Previously, the practice was to generate or simulate graph variables weekly or daily and then join the driver set with the generated graph variables accordingly. (As used herein, a “driver set” is a collection of seed entities for which graph variables need to be computed. These entities typically represent key data points such as Customer IDs or Account Numbers. The driver set serves as the input for generating graph-based features during both simulation and production.) This approach often requires a lot of computation, even if the driver set is very small. Additionally, the code required for graph variable generation often differs from the data scientists'research logic, leading to substantial efforts in translating and auditing the graph variable logic.

The traditional approach to utilizing graph variables in offline AI/ML solutions involves either using a tool such as LegoGen or writing native Spark code. Both methods require loading an entire historical graph data to generate sub-graphs, followed by applying variable calculation logic to produce the final graph variables. This approach has several drawbacks, however. First, the approach is not flexible. Data scientists must go through a complex, end-to-end process to obtain results. If the outcomes do not meet business needs, they would need to refine the sub-graph generation or variable calculation logic and repeat the process, which is time-consuming. Second, this approach heavily relies on engineering support for the data scientists, as implementing graph variables often requires additional support from engineering teams to handle complex graph logic in Python or Spark code. Third, this approach is costly, as it involves loading the entire dataset to build subgraphs, even when the driver set volume is minimal. This leads to increased costs, particularly when the job is productized in a platform such as Google® Cloud Platform (GCP). Finally, this approach has maintenance and reusability challenges. Since graph variable logic is embedded in code, it can be difficult for other data scientists to maintain. Understanding and modifying the logic requires significant effort, making it challenging to reuse graph variables or integrate them into new solutions beyond the present problem of interest.

The present disclosure recognizes that the challenges of utilizing graph variables in an offline setting can be addressed by a graph batch service that allows querying graph variables on the fly—i.e., without having to resort to cumbersome methods of constructing graphs for offline use. The proposed approach unifies the graph variable research and production processes, thereby reducing the time to market (TTM) for the entire solution. This approach allows users to explore graphs, design and test graph query and variable logic in a dynamic environment. Once the logic is validated, it can be exported as a script (e.g., Gremlin-Groovy scripts) executable by the batch graph service.

The present disclosure also recognizes that the above-noted querying of graph variables on the fly may be advantageously accomplished by introducing a mirrored graph store that continuously replicates data from an online graph store, creating a near real-time copy specifically for offline querying. In some embodiments, this mirrored setup enables offline computations to access relatively up-to-date data without impacting the performance of live online systems. Moreover, by modularizing the offline graph processing workflow into distinct components such as a user service to manage job requests, a unified graph management service (UGMS) to orchestrate processing, and an analytic graph to handle the computations, the system can support more complex and resource-efficient batch jobs. This approach minimizes the need for repetitive code, allows for faster processing of complex graph variables, and provides greater flexibility for integration with various artificial intelligence and machine learning workflows.

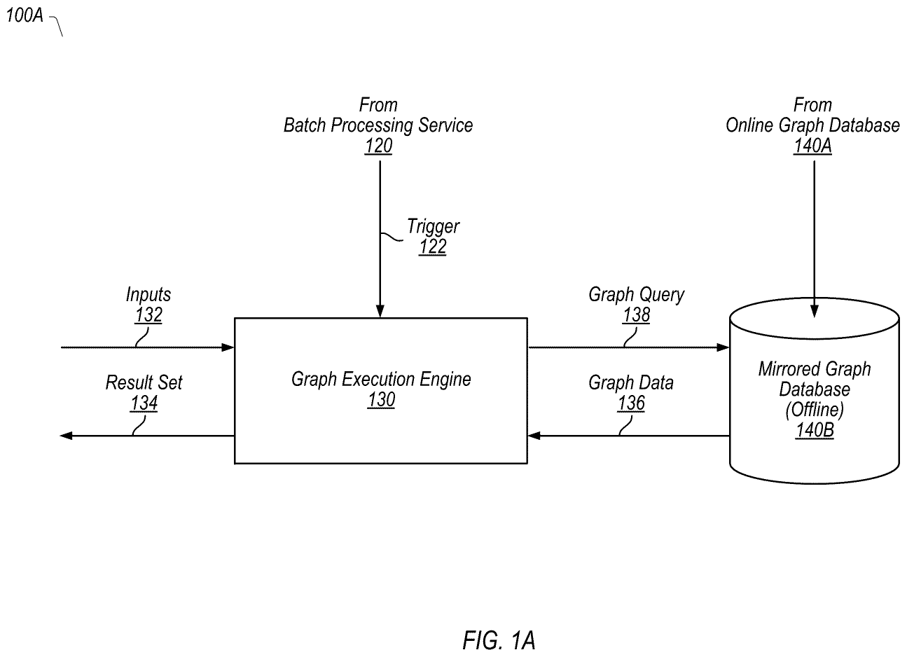

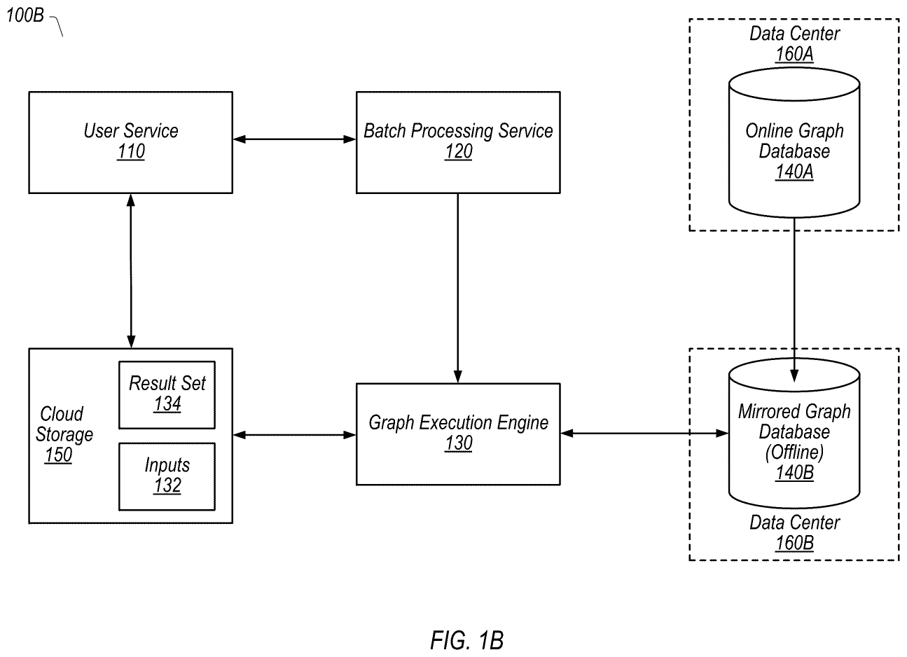

FIG. 1A is a block diagram of one embodiment of a computer system that performs batch processing using an offline mirrored graph database. As depicted, computer system 100A includes a graph execution engine 130 in communication with an offline mirrored graph database 140B. Computer system 100A facilitates batch computations on an offline version of a graph database 140B mirrored from an online graph database 140A.

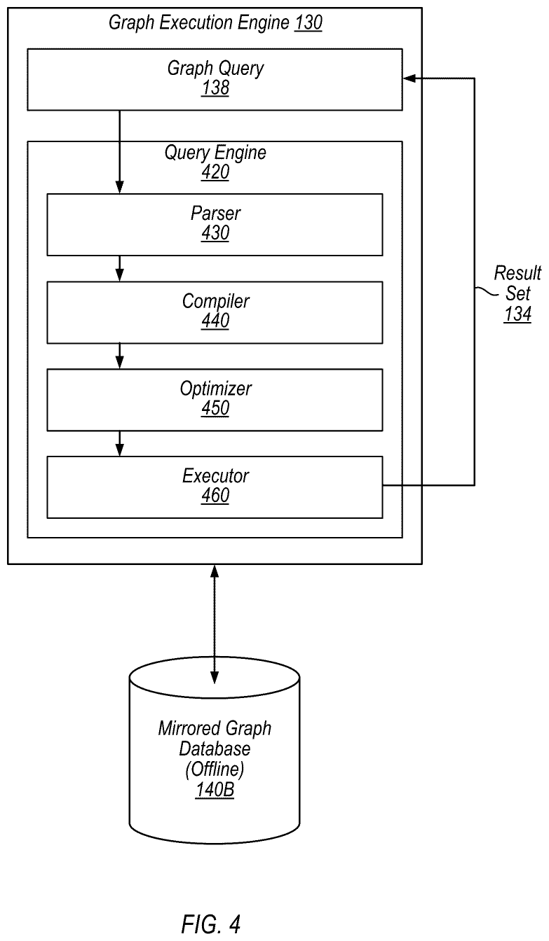

Graph execution engine 130 is operable to perform graph queries on graph database 140B. Common types of graph queries include traversal queries (navigating through relationships between nodes), pattern matching queries (finding specific patterns of connections), hop queries (finding nodes within a certain distance from a starting node), property filtering queries (filtering nodes based on their properties), and connected component analysis (identifying groups of interconnected nodes). Graph queries may be written in any number of suitable graph query languages, including Cypher, Gremlin, SPARQL, etc. Gremlin in particular is useful in that it is well-suited to complex graph traversals, which enables data scientists to develop more advanced algorithms. Additional details regarding internals of graph execution engine 130 are provided below with respect to FIG. 4.

Graph execution engine 130 performs graph computations based on a trigger 122 received from a batch processing service 120. Trigger 122 corresponds to an indication of a batch processing request to perform one or more computations. The graph execution engine 130 processes inputs 132 associated with the request (e.g., such as graph queries, driver sets, or parameters) required for execution.

Graph execution engine 130 communicates with offline mirrored graph database 140B to perform the one or more computations. For instance, graph execution engine 130 initiates a graph query 138 to offline mirrored graph database 140B, retrieves graph data 136 corresponding to graph query 138, and processes graph data 136 to generate result set(s) 134. The result set 134 represents the output of the computations performed by graph execution engine 130 and includes information derived from graph data 136, including, but not limited to, subgraphs, graph variables, or aggregated metrics. Subgraphs refer to smaller portions of the graph that meet specific query conditions, such as identifying connected components or multi-hop relationships. Graph variables include features or attributes extracted from the graph data, such as vertex counts, edge weights, or centrality measures, which can be used for further analysis. Aggregated metrics provide statistical insights derived from the graph data, such as node degrees, path lengths, or cluster densities.

Note that in many cases, particularly for enterprise applications, the size of graph database 140 is enormous. Graph databases with at least 1 million nodes, 100 million nodes, 500 million nodes, and 1 billion nodes are possible. The sheer size of data that is available to enterprises implementing information sharing services such as social networks, payment networks, and the like makes the structure of graph databases necessary. Note that for certain applications, such as payment networks, even the daily volume of transactions (and resulting entries in the graph database) is huge.

Computer system 100A provides many advantages over traditional offline graph processing implementations. For instance, unlike current offline systems that operate as monolithic programs triggered by command-line instructions, computer system 100A can modularize the offline batch computation process into distinct components. For example, graph execution engine 130 may function as the executor of computations, batch processing service 120 may act as the internal manager and communicator, and a user service 110 (described below with respect to FIG. 1B) may provide an external interface for integration. This separation of components introduces greater flexibility for integration across different customer needs, which allows batch computations to be triggered not only through command-line execution but also via requests to batch processing service 120 or through user service 110. Additionally, computer system 100A may support automatic retry on failure for robustness when initiating computations.

Compared to current online graph processing implementations, computer system 100A operates asynchronously and relaxes latency restrictions associated with synchronous requests. For instance, while online systems can impose a request latency limit of 100 milliseconds, computer system 100A can extend this threshold to 30 seconds in one embodiment, which enables deeper and more complex graph computations. Furthermore, computer system 100A can perform a greater number of multi-hop traversals (e.g., up to 5 hops) than online graph database systems, and thus execute more advanced graph calculations, such as cycle detection and graph variable development. The computer system 100A can further enhance integration capabilities by supporting cloud storage as both an input and output source, providing flexibility for data retrieval, processing, and result storage.

Mirrored graph database 140B being synchronized with online graph database 140A enables offline computations to be performed on up-to-date, consistent data. This approach can combine the benefits of offline batch processing with the accuracy of near real-time graph data, without impacting the performance of live operations on online graph database 140A. The configurable workflows of computer system 100A further enable multiple stages to be defined within a single job, where the completion of one stage can trigger subsequent stages, allowing for efficient and streamlined batch computations.

In summary, computer system 100A introduces many advantages over traditional online and offline graph processing systems. By leveraging a mirrored graph database 140B synchronized with online graph database 140A via one-way replication, computer system 100A enables data consistency while eliminating the need for repeated reconstruction of graphs, thereby reducing computational overhead. The modular separation of components, including user service 110, batch processing service 120, and graph execution engine 130, provides greater flexibility, enabling batch jobs to be triggered programmatically or through user interfaces, unlike monolithic offline implementations. Additionally, the system supports automatic retry mechanisms on failure, Representational State Transfer Application Programming Interface (REST API) integration, and cloud storage as both an input and output source, providing a cost-effective and scalable solution for enterprise use.

FIG. 1B is a block diagram of one embodiment of a computer system 100B that performs batch processing using an offline mirrored graph database. As depicted, computer system 100B includes interactions between user service 110, batch processing service 120, cloud storage 150, graph execution engine 130, and offline mirrored graph database 140B, which is mirrored from online graph database 140A. Computer system 100B facilitates batch computations on an offline version of a graph database 140B mirrored from an online graph database 140A.

FIG. 1B expands on additional components and their roles beyond graph execution engine 130 and mirrored graph database 140B. User service 110 provides an external interface for initiating and monitoring batch processing jobs, while cloud storage 150 facilitates storage and retrieval of inputs 132 and result set 134.

In the depicted embodiment, mirrored graph database 140B resides in a separate data center 160B with respect to online graph database 140A, which resides in data center 160A. This separation may correspond to geographically distinct locations or logical isolation within a single data center 160, depending on deployment requirements. Synchronization between the two databases 140 may be achieved through one-way cross-data replication mechanism, such that mirrored graph database 140B maintains a near real-time copy of the graph data for offline computations without impacting online operations. One-way replication ensures that updates to graph database 140A, which may be the production database used for live interactions with users of computer system 100B, are replicated to graph database 140B periodically, but graph database 140B is not itself written with new information. In some embodiments, replication is managed by a graph storage platform (e.g., AEROSPIKE), with replication delays typically limited to a few minutes.

Computer system 100B also supports cross-zone execution, overcoming the limitations of current offline solutions that require multiple deployments across different zones (e.g., primary area zone (PAZ), high resiliency zone (HRZ)). Computer system 100B can deploy graph execution engine 130 and batch processing service 120 in a single zone (e.g., HRZ), where batch processing service 120 can handle cross-zone communication and receive batch computation requests seamlessly from multiple zones. This architecture simplifies deployment and operational maintenance while providing a scalable solution for enterprise use.

Cloud storage 150 serves as a centralized repository for managing inputs 132 (e.g., driver sets, queries) and result set 134 generated during batch processing. The graph execution engine 130 retrieves inputs 132 from cloud storage 150 to execute batch jobs and stores the resulting computations as result set 134 back into cloud storage 150.

Cloud storage 150 enables downstream systems or services, such as user service 110, to access result set 134. For instance, user service 110 retrieves result set 134 for further analysis, integration, or reporting. The user service 110 polls batch processing service 120 for status updates on the batch job or to receive a notification upon its completion, at which point result set 134 becomes available for retrieval.

In summary, computer system 100B comprises a modular architecture that includes user service 110, batch processing service 120, graph execution engine 130, cloud storage 150, and mirrored graph database 140B. User service 110 serves as the interface for initiating, monitoring, and retrieving batch processing results. Batch processing service 120 acts as the orchestrator, coordinating batch job execution by communicating with graph execution engine 130. Graph execution engine 130 retrieves inputs 132 from cloud storage 150, executes graph computations using mirrored graph database 140B, and outputs the result set 134 back to cloud storage 150. The mirrored graph database 140B, synchronized via one-way cross-data replication from online graph database 140A, provides consistent, near real-time graph data for batch processing, while cloud storage 150 ensures centralized management of input and output data. Together, these components enable a scalable, efficient, and flexible system for performing offline graph computations.

To recap, various embodiments of an apparatus have been described with respect to FIGS. 1A-B. One such apparatus, with reference to exemplary reference numerals in this disclosure, includes a computer system (100A, 100B) comprising one or more processing circuits, and a memory storing program instructions executable by the one or more processing circuits to implement an offline graph database store that is mirrored from an online version of the graph database store. The offline graph database store is illustrated as 140B in FIGS. 1A and 1B, which is mirrored from the online graph database store 140A via a one-way cross-data replication mechanism. The memory storing program instructions executable by the one or more processing circuits also implement a user service executable to receive a batch processing request from a user and submit, based on the batch processing request, a batch job creation request. The user service is operable to receive a batch processing request from a user and based on the received request, submit a batch job creation request to batch processing service 120. The memory storing program instructions executable by the one or more processing circuits also implement a graph management batch service executable to trigger the batch job based on receiving the batch job creation request. The graph management batch service is illustrated as batch processing service 120, which is operable to trigger the batch job by sending an indication (e.g., trigger 122) to graph execution engine 130 upon receiving the batch job creation request from user service 110. The memory storing program instructions executable by the one or more processing circuits also implement a graph execution engine executable to receive an indication of the batch job from the graph management batch service, initiate a query corresponding to the batch job to the offline graph database store, receive graph data corresponding to the query, perform (using the graph data) a set of computations corresponding to the batch job to generate a result set, and output the result set. The graph execution engine 130 receives an indication of the batch job from batch processing service 120 (e.g., trigger 122). The graph execution engine 130 initiates a query (e.g., graph query 138) to offline mirrored graph database 140B, retrieves corresponding graph data 136, and performs a set of computations using the retrieved graph data to generate a result set 134. The result set 134 is then output to a storage location, such as cloud storage 150.

In some embodiments, the computer system further comprises a cloud storage configured to store the result set and an input driver set corresponding to the batch processing request. The cloud storage 150 stores result set 134 generated by graph execution engine 130 and input driver sets 132 corresponding to the batch processing request. The cloud storage 150 enables access to these data elements for downstream systems or services, including user service 110.

In some embodiments, the online graph database store is a production version used by an information sharing service, and wherein the offline graph database store is periodically mirrored from the online graph database store such that the offline graph database store includes the same content as the online graph database store, but with a latency delay. The online graph database 140A, residing in data center 160A, serves as the production graph database supporting an information sharing service (e.g., such as fraud detection, transaction monitoring, or real-time recommendation systems). This information service relies on online graph database 140A to process synchronous queries with strict latency requirements. The offline mirrored graph database 140B, residing in data center 160B, is periodically synchronized (e.g., with a latency delay) via one-way cross-data replication. This periodic replication allows offline mirrored graph database 140B to maintain near real-time data from online graph database 140A, allowing the information sharing service to continue its real-time operations uninterrupted while enabling deeper and more complex batch processing tasks on the offline graph database.

In some embodiments, the offline graph database store includes at least 100 million nodes, and is permitted to have increased latency queries relative to latency queries permitted for the online graph database store. The offline mirrored graph database 140B includes at least 100 million nodes, allowing it to handle large-scale graph computations such as multi-hop traversals or cycle detection. These operations can tolerate increased query latencies, such as up to 30 seconds, compared to the strict latency requirements (e.g., less than 100 milliseconds) of online graph database 140A.

In some embodiments, the computer system is operable to perform offline graph database store queries that include a greater number of hops than are permitted when using the online graph database store. The offline mirrored graph database 140B is operable to process graph queries that include up to five hops, enabling deeper traversal through graph structures to identify complex relationships such as transaction loops or multi-layer connections between entities. In contrast, online graph database 140A, constrained by real-time latency requirements (e.g., less than 100 milliseconds), supports only up to two hops. This extended hop capability of the offline mirrored graph database 140B facilitates advanced analyses, such as detecting money laundering patterns or exploring extensive network relationships, which can require traversing multiple intermediate nodes.

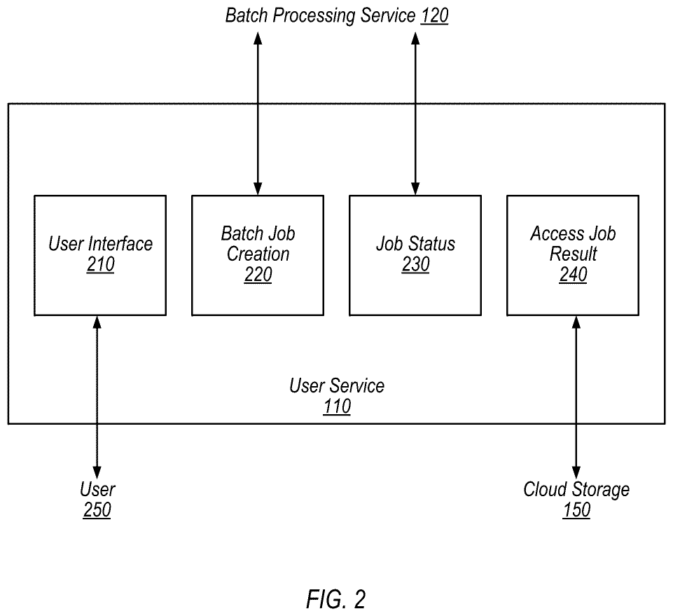

FIG. 2 is a block diagram of one embodiment of a user service within a computer system for graph database processing. As depicted, user service 110 includes user interface 210, batch job creation 220, job status 230, and access job result 240. User service 110 facilitates the initiation, monitoring, and retrieval of batch processing jobs within the computer system (e.g., computer systems 100A, 100B).

User interface 210 provides a front-end interface for a user 250 to interact with user service 110. Through user interface 210, user 250 can input requests, monitor the progress of batch processing jobs, and retrieve results. The two-way communication between user interface 210 and user 250 enables dynamic interactions, such as submitting batch job creation requests, polling for job status updates, or retrieving completed results.

Batch job creation 220 is responsible for initiating batch jobs by communicating with batch processing service 120. The two-way communication between batch job creation 220 and batch processing service 120 allows batch job creation 220 to send batch job requests and receive acknowledgments or validation from batch processing service 120. For instance, batch job creation 220 may include sending details such as graph queries, driver sets, or parameters that are required to execute a batch computation.

Job status 230 enables user service 110 to monitor the progress of batch processing jobs. Through its two-way communication with batch processing service 120, job status 230 can query the current status of a batch job and receive updates, such as whether a job is pending, in progress, completed, or failed. This functionality allows user 250 to poll for job status through user interface 210 and receive real-time updates regarding the execution of the batch job.

Access job result 240 facilitates the retrieval of results generated by completed batch jobs. Access job result 240 communicates with cloud storage 150 to retrieve the result set 134 corresponding to a batch processing request. The two-way communication between access job result 240 and cloud storage 150 enables seamless access to result set 134 (e.g., outputs of the computations performed by graph execution engine 130). User 250, through user interface 210, can request and access the results for further analysis, reporting, or integration with downstream systems.

In summary, user service 110 provides a modular and interactive interface that integrates user input, job initiation, progress monitoring, and result retrieval. The two-way communication between its components such as user interface 210, batch job creation 220, job status 230, and access job result 240, and external components such as batch processing service 120 and cloud storage 150, provides a streamlined and efficient workflow for managing batch processing jobs within the computer system.

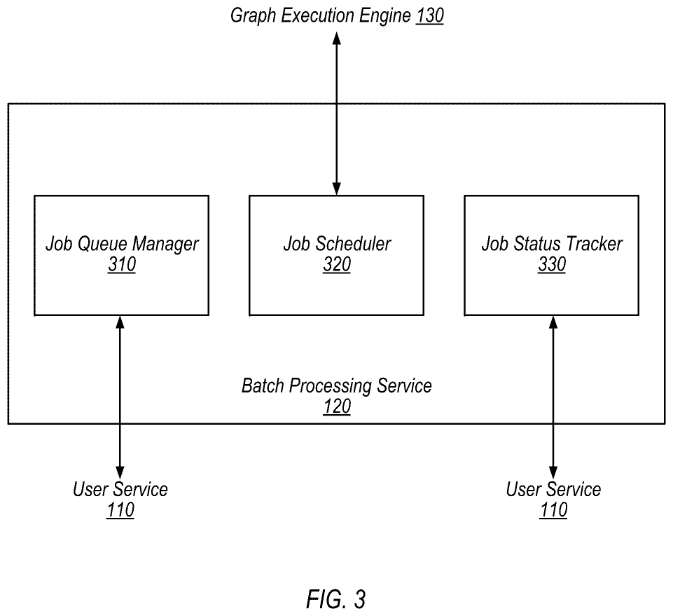

FIG. 3 is a block diagram of one embodiment of a batch processing service within a computer system for graph database processing. As depicted, batch processing service 120 includes job queue manager 310, job scheduler 320, and job status tracker 330. Batch processing service 120 facilitates orchestration, scheduling, and monitoring of batch processing jobs within the computer system (e.g., computer systems 100A, 100B).

Job queue manager 310 handles the intake and queuing of batch job requests received from user service 110. The two-way communication between job queue manager 310 and user service 110 enables user service 110 to submit batch job requests and receive acknowledgments, such that job requests are appropriately queued and validated for execution. Job queue manager 310 organizes the incoming batch jobs, prioritizes them as needed, and prepares them for scheduling.

Job scheduler 320 is responsible for scheduling and triggering the execution of queued batch jobs. The two-way communication between job scheduler 320 and graph execution engine 130 enables job scheduler 320 to send triggers (e.g., job initiation signals) to graph execution engine 130 for processing the batch jobs. Job scheduler 320 also allows optimal utilization of resources by efficiently allocating jobs for execution based on system load, job priority, or other predefined parameters.

Job status tracker 330 monitors the progress and status of batch jobs in real time. Through its two-way communication with user service 110, job status tracker 330 provides updates regarding the status of batch jobs (e.g., pending, in progress, completed, or failed). This interaction allows user service 110 to query the current status of jobs or receive notifications when a job has been completed.

In summary, batch processing service 120 coordinates the entire lifecycle of batch jobs, from job submission and scheduling to execution and monitoring. In some embodiments, batch processing service 120 may be designated as a Unified Graph Management Service (UGMS). Job queue manager 310 handles incoming job requests, job scheduler 320 triggers job execution through graph execution engine 130, and job status tracker 330 monitors and reports job progress. The modular design and two-way communication between these components and external entities, such as user service 110 and graph execution engine 130, provides efficient and scalable batch job orchestration within the computer system.

FIG. 4 is a block diagram of one embodiment of a graph execution engine within a computer system that performs batch processing. As depicted, graph execution engine 130 includes graph query 138 and query engine 420, and is in communication with mirrored offline graph database 140B. Graph execution engine 130 facilitates the initiation, execution, and processing of graph computations as part of a batch job.

Graph execution engine 130 receives graph queries 138, which define the operations to be performed on mirrored graph database 140B. In some embodiments, graph execution engine 130 may be designated as an analytic graph which refers to its ability to perform complex graph computations, including multi-hop queries and advanced graph analyses. Graph query 138 serves as the input that drives the computational workflow within graph execution engine 130. The graph query 138 is processed by query engine 420, which comprises multiple stages for parsing, compiling, optimizing, and executing the query. Query engine 420 supports a wide range of built-in graph algorithms, including, but not limited to, Page Rank, Connected Component, Louvain, the Shortest Path, Label Propagation Algorithm, and Closeness Centrality.

Query engine 420 includes parser 430, compiler 440, optimizer 450, and executor 460. Initially, graph query 138 is provided to parser 430, which analyzes the query structure and converts it into an intermediate representation that can be understood by subsequent components. The intermediate representation is passed to compiler 440, which generates an executable query plan that defines the steps required to process graph query 138.

The executable query plan is then processed by optimizer 450. Optimizer 450 identifies and applies one or more optimization strategies to improve the efficiency of graph query 138 execution. Although not explicitly shown, optimizer 450 may include one or more optimize strategy blocks. These blocks determine the most resource-efficient query plan based on factors such as data size, graph traversal depth, or available computational resources.

Once optimized, the query plan is executed by executor 460, which interacts with mirrored graph database 140B to retrieve and process the graph data. Mirrored graph database 140B provides graph vertices and graph edges to query engine 420 during query execution. This interaction does not rely on specific processes or protocols, but instead uses general logic for retrieving and processing graph data, which applies to both online and offline graph queries. Graph execution engine 130 communicates with mirrored graph database 140B to enable two-way data exchange, where executor 460 retrieves relevant graph data (e.g., vertices, edges, or graph variables) and executes computations based on the query logic.

Upon completing the computations, executor 460 generates result set 134, which represents the output of graph query 138. Result set 134 may include processed graph data, such as subgraphs, graph variables, or aggregated results. The result set 134 output is communicated back to graph query 138 for further use, such as outputting the results to a storage location (e.g., cloud storage 150) or integrating the results with downstream systems or services.

In summary, graph execution engine 130 performs a multi-stage query execution process involving graph query initiation, parsing, compilation, optimization, and execution. The modular design of query engine 420, including parser 430, compiler 440, optimizer 450, and executor 460, enables efficient handling of complex graph computations. The two-way communication between graph execution engine 130 and mirrored graph database 140B provides seamless data retrieval and processing, while result set 134 represents the final output generated as part of the batch processing workflow.

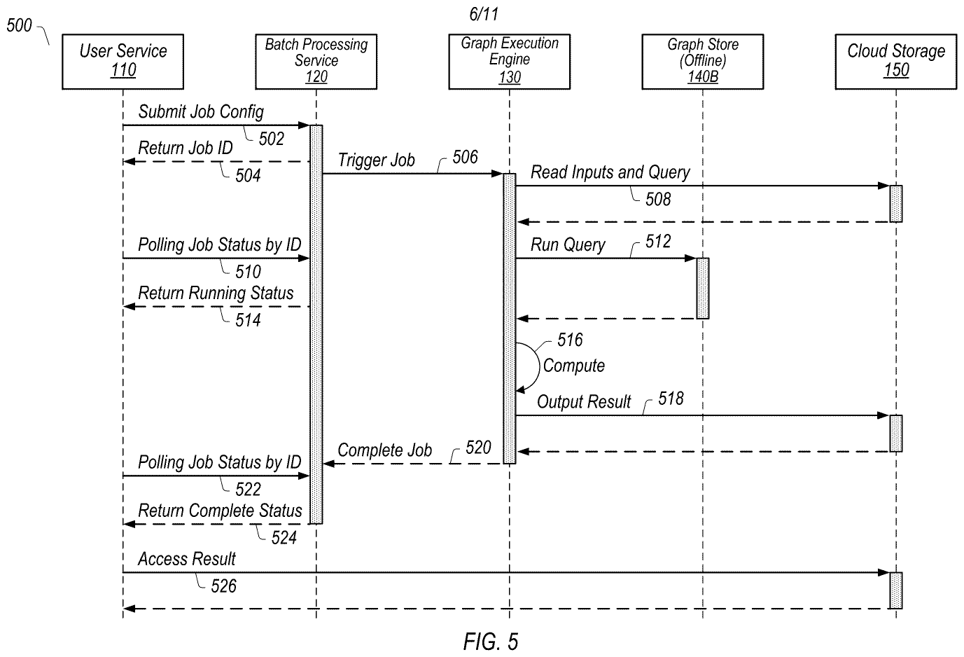

FIG. 5 is a sequence diagram of one embodiment of processing of a batch processing request. As depicted, sequence diagram 500 includes user service 110, batch processing service 120, graph execution 130, offline graph store 140B, and cloud storage 150. The sequence diagram 500 depicts the interactions and data flow between these components to facilitate the submission, execution, monitoring, and completion of a batch processing job.

The process begins when user service 110 submits a job configuration 502 to batch processing service 120, which validates the configuration and returns a job ID 504. Batch processing service 120 then triggers the batch processing job 506 by communicating with graph execution engine 130. Graph execution engine 130 retrieves input data and query configurations by sending a read inputs and query 508 request to cloud storage 150. Cloud storage 150 returns the corresponding inputs and query data to graph execution engine 130.

Once graph execution engine 130 has the input data, it sends a run query 512 request to offline graph store 140B to retrieve relevant graph data. Offline graph store 140B processes the query and returns the requested graph data to graph execution engine 130. Using the retrieved graph data, graph execution engine 130 performs computations, denoted as compute 516. These computations may include tasks such as generating subgraphs, calculating graph variables, or running graph algorithms.

Upon completing the computations, graph execution engine 130 generates a result set and outputs the results to cloud storage 150, as indicated by output result 518. Cloud storage 150 acknowledges the result storage and communicates the completion to graph execution engine 130. Graph execution engine 130 then sends a complete job 520 notification to batch processing service 120, signaling the successful execution of the batch job.

User service 110 periodically polls batch processing service 120 for job status using polling job status by ID 510. Batch processing service 120 returns the current job status, such as return running status 514, to user service 110. Once the computations are complete, user service 110 polls for the final job status again with polling job status by ID 522. Batch processing service 120 responds with a return complete status 524, indicating that the batch job has finished successfully.

After receiving the completion status, user service 110 sends an access result 526 request to cloud storage 150 to retrieve the result set. Cloud storage 150 returns the result set to user service 110, enabling the results to be accessed, analyzed, or integrated with downstream systems.

In this embodiment, the described sequence of operations illustrates one order of events for batch job processing; however, in other embodiments, the order of events may vary. The sequence diagram 500 highlights the coordination between user service 110, batch processing service 120, graph execution engine 130, offline graph store 140B, and cloud storage 150, enabling efficient retrieval, processing, and storage of batch job results.

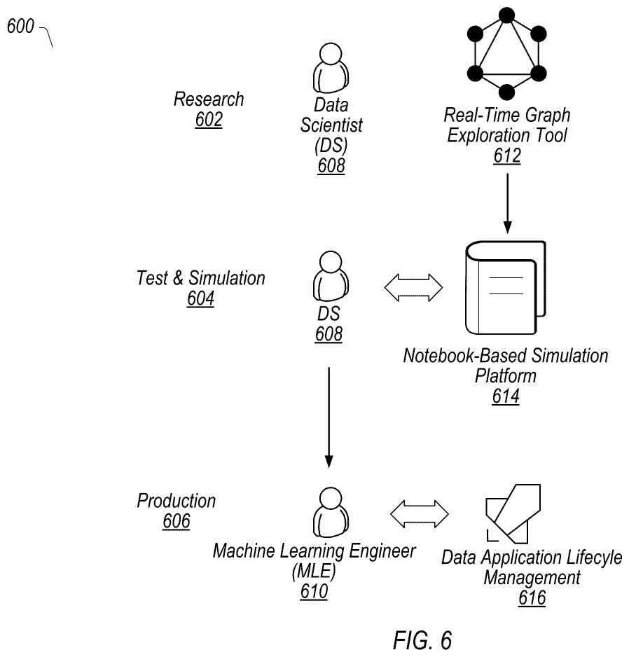

FIG. 6 is a diagram of one embodiment of a graph variable development and production lifecycle. As depicted, diagram 600 includes three phases, research 602, test & simulation 604, and production 606, that collectively streamline the process of developing and deploying graph variables for offline AI/ML solutions. This approach has multiple benefits, including enhanced time and cost efficiency, as graph databases significantly improve the efficiency of generating graph-based variables during both the development and production phases, saving time and reducing resource costs; support for complex variable creation, as graph databases enable data scientists to create more sophisticated graph-based variables that were previously infeasible with SQL due to limitations in memory and computational resources; streamlined script management and reusability, since in the future, both online and offline graph scripts can be consolidated for better organization, allowing data scientists to cross-reference and reuse scripts more effectively, fostering collaboration and consistency; and finally, reduced time to market, since graph databases with the Gremlin query language support fast experiments during research phase and allow fluent transition from research to production.

In the research phase 602, data scientists (DS) 608 may collaborate with business partners to design graph variable logic using real-time graph exploration tool 612. This tool enables data scientists 608 to explore graph data, design graph queries, and test variable calculation logic in a dynamic environment. Sample data (e.g., seeds) can be used to immediately verify the logic. If additional functionality, such as User Defined Functions (UDFs), is required, the solution engineering team provides necessary support, such as helping optimize the graph query for detecting complex patterns. Once the graph variable logic is validated, it may be exported as a script in a graph query language (e.g., a Gremlin-Groovy script) and executed by the graph batch system (e.g., computer systems 100A-B, which support submission of batch jobs to graph database 140B). Note that running previous data science experiments in Spark code using data from BigQuery® (BQ) tables had the following disadvantages: simulating multi-hop graphs using BQ tables was very resource-intensive; graph data in tabular format had to be moved from BQ to Spark code to run graph query experiments, resulting in onerous data movement requirements; and slower processing, as graph pattern detection algorithms running in Spark code were slower compared to executing Gremlin queries on a dedicated graph database.

But using the approaches of the present disclosure, data scientist 608 teams can quickly design and test different query templates during development. Both the raw graph and graph variables can be directly exported for use in other solutions. Once the graph queries are finalized, they can be easily integrated into the production pipeline.

In the test & simulation phase 604, data scientists 608 may work within a notebook-based simulation platform 614, to generate driver sets and execute graph variable simulations. This phase supports dynamic iteration through notebook “magic” commands that enable submission of simulation jobs. (Notebook magic commands are special commands that simplify repetitive tasks and enhance notebook interactivity. In the context of simulation, the following magic commands are commonly used: %simservice_request, which submits a simulation job with the required parameters; and %simservice_utils, which provides utility functions, such as uploading a graph query template.) After the simulation jobs are complete, data scientists 608 may apply post-processing logic to refine the graph variable results. The results are then audited and can be directly applied for model training. The two-way communication between DS 608 and notebook-based simulation platform 614 represents the iterative nature of graph variable testing, where outcomes can be reviewed, refined, and validated before advancing to production. Note that the process of testing and refining variables is crucial for developing a successful model. It helps identify the optimal construction of variables that contribute to accurate and stable predictions. Graph-based variables often involve more complex logic than standard variables (such as a simple transaction count from the past month). This added complexity requires more iterations to fine-tune. Leveraging an offline graph database through a notebook-based simulation platform accelerates this process, providing greater flexibility and efficiency for exploring and refining these variables.

In the production phase 606, the validated graph variable logic, along with any post-processing scripts, is handed over to the Machine Learning Engineer (MLE) 610. MLE 610 reviews the logic, integrates the graph components into the production environment, and conducts necessary tests. Successful tests ensure the graph variables are ready for deployment alongside the solution code. Note that once the simulation results of graph variables demonstrate that they have the intended impact on model performance during the training process, data scientists 608 can mark the variables as production-ready. During this phase, MLE 610 works closely with data application lifecycle management 616 to ensure deployment, maintenance, and integration of graph variables into the production environment. The two-way communication between MLE 610 and data application lifecycle management 616 ensures continuous alignment and lifecycle management of graph components. In prior approaches, ensuring graph variables were production-ready included developing separate Spark code for generating graph variables for each use case, which required significant time for development and testing. With the approach of the present disclosure, data scientists 608 can create graph queries during the research phase, which are then reused for both simulation and production deployment. This eliminates the need to develop separate Spark code for each use case. The deployment of graph variables thus follows a configuration-based model. The graph component is developed once and reused across different graph variables by applying distinct configurations. These configurations include the graph query and the location of the driver set in cloud storage. This streamlined process reduces development and deployment time.

The diagram 600 further highlights the streamlined workflow between phases. For instance, data scientists 608 in test & simulation phase 604 pass validated graph logic to machine learning engineers 610 for production deployment. This handoff process reduces dependence on engineering support and accelerates the iterative refinement of graph variables. In some embodiments, a graph client is utilized to streamline the integration of graph variables into offline AI/ML solution pipelines. The graph client can interface with the batch processing system by submitting batch jobs to graph database 140B (e.g., via graph execution engine 130), monitoring job status, and loading graph variable outputs into designated storage systems, such as BigQuery® tables or Google® Cloud Storage (GCS). For instance, the graph client may prepare seeds from a driver set stored in a BigQuery table®, export them as CSV files to a GCS location, and initiate a batch job with parameters specifying the graph query and driver set locations. While real-time graph exploration tool 612 provides real-time graph exploration and validation capabilities during the research phase, the batch graph service described herein enables large-scale, offline batch computations for graph variable generation with relaxed latency requirements. The batch graph service further supports asynchronous job scheduling, including automatic retry mechanisms on failure and notifications of job completion. These features ensure robust and efficient execution of batch jobs, minimizing disruptions during production deployment. Additionally, the configuration-based nature of the system allows users to define inputs, such as driver sets and action triggers, while supporting flexible storage backends like GCS and Apache® Hadoop® Distributed File System (HDFS). By leveraging these capabilities, graph variables can be seamlessly embedded into offline AI/ML solutions, enhancing integration, scalability, and overall efficiency of the deployment lifecycle.

In summary, FIG. 6 illustrates a redefined graph variable development lifecycle that includes research phase 602, test & simulation phase 604, and production phase 606. By leveraging tools such as real-time graph exploration tool and notebook-based simulation platform 614, the new lifecycle enable data scientists 608 to take ownership of the majority of the process. This approach addresses challenges such as lack of flexibility, engineering dependencies, and high costs in traditional methods, significantly improving the speed, reusability, and efficiency of offline AI/ML solutions.

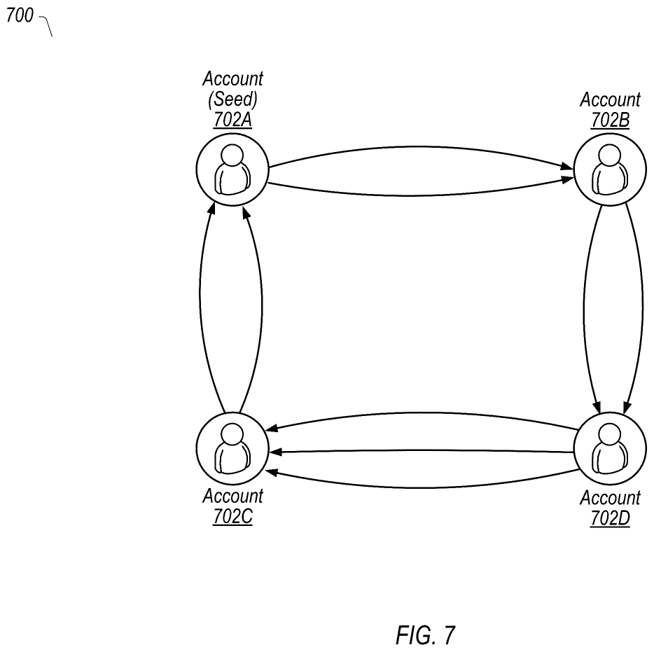

FIG. 7 is a block diagram illustrating one embodiment of a graph-based detection of circular money movement. As depicted, diagram 700 includes seed account 702A, account 702B, account 702C, and account 702D, with connections representing transactions between the accounts. Diagram 700 illustrates a transaction loop where funds originating from the seed account 702A are transferred through multiple accounts and ultimately return to the seed account 702A.

Account 702A serves as the initial sender, initiating a transaction that propagates through accounts 702B, 702C, and 702D in sequence before returning to account 702A. Such patterns are indicative of a potential “Circular Money Movement,” a common typology in the Anti-Money Laundering (AML) domain. Circular money movement occurs when funds traverse through multiple accounts and loop back to the origin, often signaling attempts to layer or obscure illicit transactions.

The embodiment of FIG. 7 is based on PayPal®'s graph-based multi-hop detection solution. Traditional approaches relying on tabular data face computational challenges in identifying multi-hop transaction patterns, especially as the number of hops increases. By leveraging graph technology, transaction loops such as the one shown in FIG. 7 can be efficiently detected within manageable computation times. Specifically, graph-based solutions enable transaction loop searches of up to five hops, significantly improving detection capabilities over tabular methods.

Detecting circular money flows provides tangible benefits to AI/ML solutions. First, it enhances the ability to identify high-risk accounts and multi-account behaviors indicative of potential laundering. For instance, the loop detected in FIG. 7 may prompt further investigation by experienced analysts, who inspect transaction patterns and account behaviors to determine whether a Suspicious Activity Report (SAR) should be filed for seed account 702A. Second, this graph-based approach improves AI/ML model performance, as transaction loops can be visualized and validated, supporting guided investigations.

In summary, FIG. 7 highlights the broader utility of graph-based detection methodologies in identifying complex transaction patterns. Beyond Anti-Money Laundering (AML) use cases, similar approaches can be applied in other domains, such as Brand Risk Management (BRM), where multi-hop transactional links are traced to identify alternative seller behaviors following restrictions. By enabling efficient searches, graph-based solutions may enhance detection accuracy, improve investigative workflows, and support downstream processes like model validation and guided analysis.

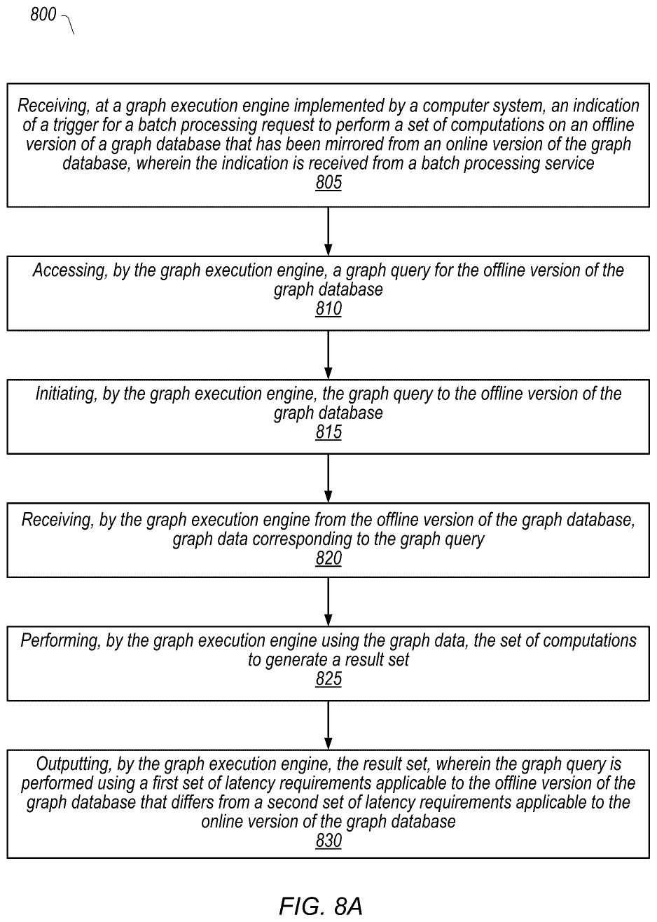

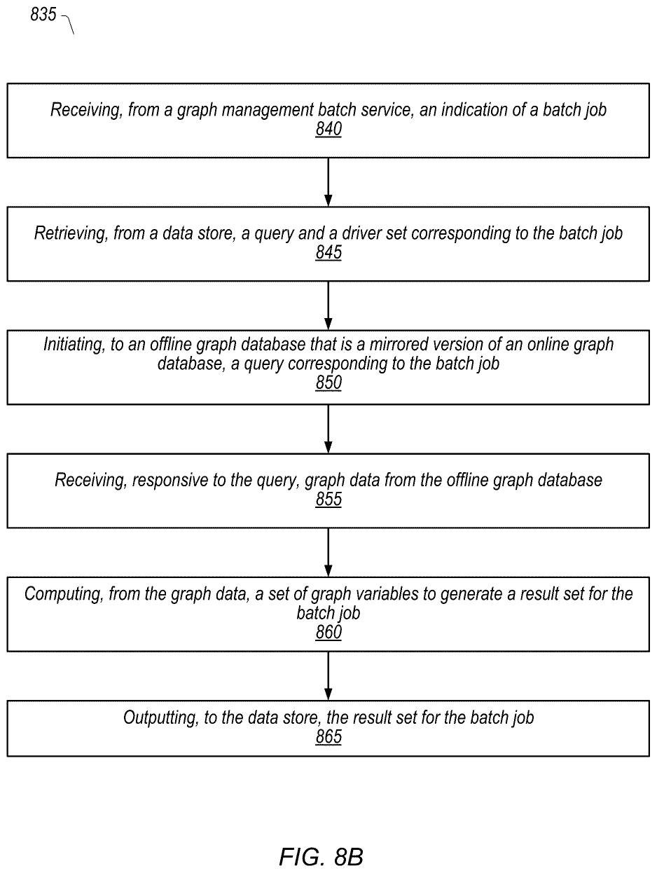

FIG. 8A is a flow diagram of one embodiment of a method for performing batch processing using an offline mirrored graph database. Method 800 may be performed by a computer system. For example, method 800 may be performed by computer system 100A or computer system 100B. Method 800 has many variations, including those described below.

Method 800 includes, at 805, receiving, at a graph execution engine implemented by a computer system, an indication of a trigger for a batch processing request to perform a set of computations on an offline version of a graph database that has been mirrored from an online version of the graph database, wherein the indication is received from a batch processing service. Graph execution engine 130 receives a trigger 122 from batch processing service 120, initiating the batch processing workflow. Batch processing service 120 coordinates job management, such that graph execution engine 130 retrieves the appropriate trigger 122 and proceeds with executing the requested computations.

Additionally, at 810, method 800 includes accessing, by the graph execution engine, a graph query for the offline version of the graph database. Graph execution engine 130 accesses graph query 138, which specifies the operations to be performed on offline mirrored graph database 140B.

Further, at 815, method 800 includes initiating, by the graph execution engine, the graph query to the offline version of the graph database. Graph execution engine 130 sends graph query 138 to retrieve specific graph data 136 from offline mirrored graph database 140B for processing as part of the batch job.

Moreover, at 820, method 800 includes receiving, by the graph execution engine from the offline version of the graph database, graph data corresponding to the graph query. The received graph data 136 includes vertices, edges, or other relevant graph elements required to execute the computations specified in graph query 138.

Additionally, at 825, method 800 includes performing, by the graph execution engine using the graph data, the set of computations to generate a result set. These computations may include operations such as subgraph detection, graph variable calculations, or multi-hop traversals, enabling the generation of result set 134 based on the logic specified in graph query 138.

Further, at 830, method 800 includes outputting, by the graph execution engine, the result set, wherein the graph query is performed using a first set of latency requirements applicable to the offline version of the graph database that differs from a second set of latency requirements applicable to the online version of the graph database. Offline mirrored graph database 140B supports relaxed latency requirements, enabling more complex computations, such as multi-hop traversals and advanced graph variable calculations, that are not feasible under the stricter latency constraints of online graph database 140A.

In some embodiments, the online version of the graph database is stored in a first data center, and wherein the offline version of the graph database is stored in a second data center and updated via a one-way cross-data center replication sync from the online version of the graph database. For instance, online graph database 140A is stored in data center 160A, while offline mirrored graph database 140B is stored in data center 160B, with the one-way replication ensuring that offline mirrored graph database 140B maintains a near real-time copy of the data from online graph database 140A.

In some embodiments, the result set is output to a storage location that is accessible to a user service that submitted the batch processing request to the batch processing service. Result set 134, generated by graph execution engine 130, is stored in cloud storage 150. Cloud storage 150 provides centralized access to result set 134, enabling user service 110 to retrieve the results for analysis, reporting, or integration with downstream systems.

In some embodiments, the batch processing service is executable to receive a job request from a user service, submit the indication of the trigger to the graph execution engine, respond to polling requests from the user service by indicating that the batch processing request is running (while the batch processing request is in process), and responding to a polling request from the user service by indicating that the batch processing request is complete thus indicating to the user service that the result set is accessible at the storage location after the batch processing request has completed. For instance, batch processing service 120 receives a job request from user service 110 and, using job queue manager 310, submits the trigger 122 to graph execution engine 130 to initiate the batch job. Job scheduler 320 within batch processing service 120 coordinates and monitors the execution process while graph execution engine 130 performs the computations. Job status tracker 330 handles polling requests from user service 110, indicating whether the job is running or complete. Once the job has finished and result set 134 is stored in cloud storage 150, batch processing service 120 communicates the completion status to user service 110, enabling access to result set 134.

In some embodiments, the graph query can include searches that include N hops, where N is an integer greater than or equal to 3, and wherein a permitted latency for the graph query is at least 20 seconds. For instance, graph query 138 executed by graph execution engine 130 can include multi-hop traversals across offline mirrored graph database 140B. These traversals extend beyond simple single-hop queries, enabling deeper searches of graph relationships involving N hops, where N is 3 or more. The relaxed latency requirements of at least 20 seconds for offline processing allow graph execution engine 130 to efficiently perform complex analyses, such as identifying circular patterns, multi-node paths, or deeply nested relationships, which would be infeasible under the stricter latency constraints of online systems. In some embodiments, an online graph database may have a second set of latency requirements that specify a real-time performance standard, while an offline graph database may have a first set of latency requirements that specify a first latency requirements that constitute a non-real-time performance standard with latency requirements that are longer than the second set of latency requirements.

In some embodiments, the second set of performance requirements specifies that graph query latency is less than 100 ms, while the first set of performance requirements specifies that graph query latency is less than 30 seconds. The online graph database 140A operates under strict latency constraints of less than 100 milliseconds to ensure real-time responsiveness for live operations, such as fraud detection or transaction monitoring. In contrast, offline mirrored graph database 140B allows for relaxed latency requirements of up to 30 seconds, enabling graph execution engine 130 to perform computationally intensive tasks, such as multi-hop traversals, complex graph variable calculations, and cycle detection, without compromising system performance. This distinction in latency thresholds supports the execution of advanced offline queries that are impractical in real-time systems.

In some embodiments, the set of computations includes cycle detection within loops in the graph database, and wherein the graph database includes at least 1 million nodes. Graph execution engine 130 performs cycle detection computations on graph data 136 retrieved from offline mirrored graph database 140B. The graph database, which may include at least 1 million nodes, enables the identification of transaction loops or cyclical relationships among nodes, such as circular money movement patterns or other recurring structures. These computations facilitate the detection of complex graph relationships that may be challenging to identify using traditional methods.

In some embodiments, initiating the graph query includes parsing the graph query, compiling the parsed graph query, optimizing the compiled graph query, perform a set of accesses to the offline graph database based on the optimized graph query and wherein the received graph data includes graph vertices and edges from the offline graph database. For instance, graph execution engine 130 initiates graph query 138, which is processed through query engine 420. The query engine 420 performs multiple stages, beginning with parser 430 that parses graph query 138 to generate an intermediate representation. Compiler 440 compiles the parsed query into an executable query plan, which is further refined by optimizer 450 to ensure efficient execution. Executor 460 then accesses offline mirrored graph database 140B to retrieve graph data 136, including vertices and edges, required to execute the query.

In some embodiments, the set of computations include one or more of the following graph algorithms: Page Rank, Connected Component, Louvain, the Shortest Path, Label Propagation Algorithm, and Closeness Centrality. Query engine 420 within graph execution engine 130 performs these computations by executing the specified graph algorithms on graph data 136 retrieved from offline mirrored graph database 140B. These algorithms enable advanced graph analyses, such as identifying influential nodes, detecting clusters, calculating shortest paths, and propagating labels across graph structures.

In some embodiments, the offline version of the graph database permits querying new graph variables on the fly, without having to generate new code to access the new graph variables. For instance, graph execution engine 130, through query engine 420, enables dynamic queries to define and retrieve new graph variables directly from offline mirrored graph database 140B. This capability leverages the flexibility of graph query 138 and the modular design of query engine 420, allowing users to specify new variables or computations without requiring additional code development or redeployment.

FIG. 8B is a flow diagram of one embodiment of a method for performing batch processing using an offline mirrored graph database. Method 835 may be performed by a computer system. For example, method 835 may be performed by computer system 100A or computer system 100B. Method 835 has many variations, including those described below.

Method 835 includes, at 840, receiving, from a graph management batch service, an indication of a batch job. Graph execution engine 130 receives a trigger 122 of the batch job from batch processing service 120, which coordinates the submission and management of the batch job request.

Additionally, at 845, method 835 includes retrieving, from a data store, a query and a driver set corresponding to the batch job. For instance, graph execution engine 130 retrieves graph query 138 and driver set (e.g., which are part of inputs 132) from cloud storage 150. Cloud storage 150 serves as the centralized repository, enabling efficient access to the query and driver set required to execute the batch job.

Further, at 850, method 835 includes initiating, to an offline graph database that is a mirrored version of an online graph database, a query corresponding to the batch job. Graph execution engine 130 initiates graph query 138 to offline mirrored graph database 140B. This query enables the retrieval of relevant graph data 136 for performing computations as part of the batch job, leveraging the mirrored offline graph database 140B for deeper analysis with relaxed latency constraints.

Moreover, at 855, method 835 includes receiving, responsive to the query, graph data from the offline graph database. Graph execution engine 130 receives graph data 136 from offline mirrored graph database 140B in response to graph query 138. The graph data 136 may include vertices, edges, or other graph elements necessary for performing computations specified by the batch job.

Additionally, at 860, method 835 includes computing, from the graph data, a set of graph variables to generate a result set for the batch job. Graph execution engine 130 processes graph data 136 retrieved from offline mirrored graph database 140B to compute graph variables, such as node metrics, edge weights, or centrality measures, using query engine 420. The computations result in result set 134, which represents the output of the batch job and includes the derived graph variables for further analysis.

Further, at 865, method 835 includes outputting, to the data store, the result set for the batch job. Graph execution engine 130 outputs result set 134 to cloud storage 150, enabling downstream systems or user service 110 to retrieve and utilize the computed data for integration, reporting, or further processing.

In some embodiments, method 835 further includes retrying the query in response to a failure of an initial attempt to initiate the query. For instance, graph execution engine 130, upon encountering a failure during the initial attempt to initiate graph query 138 to offline mirrored graph database 140B, automatically retries query 138 as part of a fault-tolerant mechanism. This ensures the successful retrieval of graph data 136 despite transient errors, maintaining robustness in batch job execution.

Various techniques described herein, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

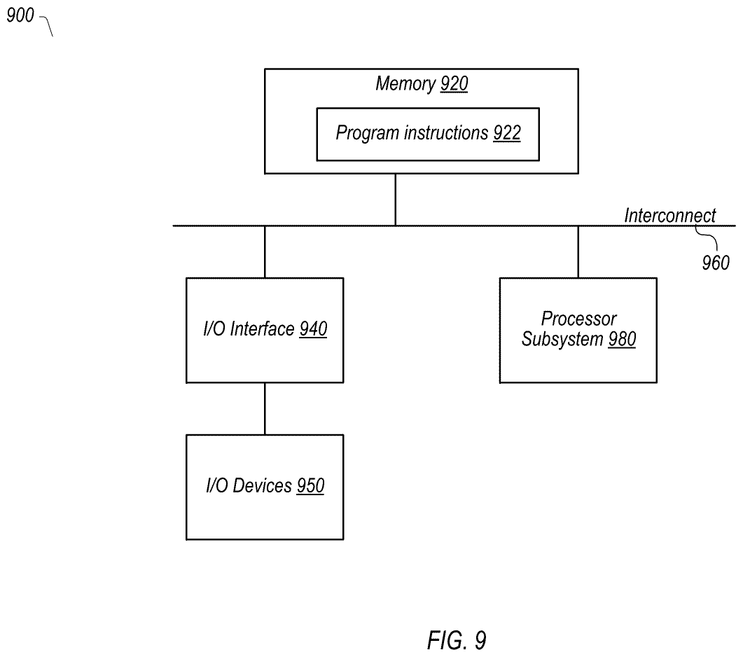

Similarly, systems that implement the methods described with respect to any of the disclosed techniques are also contemplated. One such system is described with reference to FIG. 9. FIG. 9 is a block diagram of another embodiment of such a computer system. Computer system 900 includes a processor subsystem 980 that is coupled to a system memory 920 and I/O interfaces(s) 940 via an interconnect 960 (e.g., a system bus). I/O interface(s) 940 is coupled to one or more I/O devices 950. Computer system 900 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 900 is shown in FIG. 9 for convenience, system 900 may also be implemented as two or more computer systems operating together.

Processor subsystem 980 may include one or more processors or processing units. In various embodiments of computer system 900, multiple instances of processor subsystem 980 may be coupled to interconnect 960. In various embodiments, processor subsystem 980 (or each processor unit within 980) may contain a cache or other form of on-board memory.

System memory 920 is usable to store program instructions executable by processor subsystem 980 to cause system 900 to perform various operations described herein. System memory 920 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 900 is not limited to primary storage such as memory 920. Rather, computer system 900 may also include other forms of storage such as cache memory in processor subsystem 980 and secondary storage on I/O Devices 950 (e.g., a hard drive, storage array, etc.). In some embodiments, these other forms of storage may also store program instructions executable by processor subsystem 980.

I/O interfaces 940 may be any of various types of interfaces configured to couple to and communicate with other devices, according to various embodiments. In one embodiment, I/O interface 940 is a bridge chip (e.g., Southbridge) from a front-side to one or more back-side buses. I/O interfaces 940 may be coupled to one or more I/O devices 950 via one or more corresponding buses or other interfaces. Examples of I/O devices 950 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 900 is coupled to a network via a network interface device 950 (e.g., configured to communicate over WiFi, Bluetooth, Ethernet, etc.).

Memory 920 may include a non-transitory computer-readable storage medium storing program instructions 922 in various embodiments. Program instructions 922 may include instructions that are executable to perform methods described with respect to FIGS. 8A-B, for example.

One particular environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together to provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, nonredundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” be used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
receiving, at a graph execution engine implemented by a computer system, an indication of a trigger for a batch processing request to perform a set of computations on an offline version of a graph database that has been mirrored from an online version of the graph database, wherein the indication is received from a batch processing service;
accessing, by the graph execution engine, a graph query for the offline version of the graph database;
initiating, by the graph execution engine, the graph query to the offline version of the graph database;
receiving, by the graph execution engine from the offline version of the graph database, graph data corresponding to the graph query;
performing, by the graph execution engine using the graph data, the set of computations to generate a result set; and
outputting, by the graph execution engine, the result set;
wherein the graph query is performed using a first set of latency requirements applicable to the offline version of the graph database that differs from a second set of latency requirements applicable to the online version of the graph database.

2. The method of claim 1, wherein the online version of the graph database is stored in a first data center, and wherein the offline version of the graph database is stored in a second data center and updated via a one-way cross-data center replication sync from the online version of the graph database.

3. The method of claim 1, wherein the result set is output to a storage location that is accessible to a user service that submitted the batch processing request to the batch processing service.

4. The method of claim 1, wherein the batch processing service is executable to:
receive a job request from a user service;
submit the indication of the trigger to the graph execution engine;
while the batch processing request is in process, respond to polling requests from the user service by indicating that the batch processing request is running;
after the batch processing request has completed, responding to a polling request from the user service by indicating that the batch processing request is complete, thus indicating to the user service that the result set is accessible at the storage location.

5. The method of claim 1, wherein the graph query can include searches that include N hops, where N is an integer greater than or equal to 3, and wherein a permitted latency for the graph query is at least 20 seconds.

6. The method of claim 1, wherein the second set of performance requirements specifies that graph query latency is less than 100 ms, while the first set of performance requirements specifies that graph query latency is less than 30 seconds.

7. The method of claim 1, wherein the second set of latency requirements specify a real-time performance standard, while the first set of latency requirements specifies latency requirements that constitute a non-real-time performance standard with latency requirements that are longer than the second set of latency requirements.

8. The method of claim 5, wherein the set of computations includes cycle detection within loops in the graph database, and wherein the graph database includes at least 1 million nodes.

9. The method of claim 1, wherein initiating the graph query includes:
parsing the graph query;
compiling the parsed graph query;
optimizing the compiled graph query;
perform a set of accesses to the offline graph database based on the optimized graph query; and
wherein the received graph data includes graph vertices and edges from the offline graph database.

10. The method of claim 1, wherein the offline version of the graph database permits querying new graph variables on the fly, without having to generate new code to access the new graph variables.

11. A non-transitory computer-readable medium having program instructions stored thereon that are executable by a graph execution engine implemented by a computer system to perform operations comprising:
receiving, from a graph management batch service, an indication of a batch job;
retrieving, from a data store, a query and a driver set corresponding to the batch job;
initiating, to an offline graph database that is a mirrored version of an online graph database, a query corresponding to the batch job;
receiving, responsive to the query, graph data from the offline graph database;
computing, from the graph data, a set of graph variables to generate a result set for the batch job; and
outputting, to the data store, the result set for the batch job.

12. The computer-readable medium of claim 11, wherein the operations further comprise:
retrying the query in response to a failure of an initial attempt to initiate the query.

13. The computer-readable medium of claim 11, wherein the query is permitted to include up to 5 hops across at least nodes in the offline graph database.

14. The computer-readable medium of claim 11, wherein the program instructions include program instructions executable by the graph management batch service to perform operations comprising:
receiving a job request from a user service;
triggering the batch job by sending an indication to the graph execution engine;
tracking a status of the batch job during execution and providing one or more status updates to the user service; and
upon completion of the batch job, notifying the user service that the batch job is complete.

15. The computer-readable medium of claim 11, wherein the program instructions include program instructions executable by the user service to perform operations comprising:
in response to user input, send a job request to the graph management batch service;
receive polling information from the graph management batch service indicating status of the batch job; and
retrieve, from a result data store after receiving polling information indicating the batch job is complete, results of the batch job.

16. A computer system, comprising:
one or more processing circuits;
a memory storing program instructions executable by the one or more processing circuits to implement:
an offline graph database store that is mirrored from an online version of the graph database store;
a user service executable to:
receive a batch processing request from a user; and
submit, based on the batch processing request, a batch job creation request;
a graph management batch service executable to trigger the batch job based on receiving the batch job creation request;
a graph execution engine executable to:
receive an indication of the batch job from the graph management batch service;
initiate a query corresponding to the batch job to the offline graph database store;
receive graph data corresponding to the query;
perform, using the graph data, a set of computations corresponding to the batch job to generate a result set; and
output the result set.

17. The computer system of claim 16, further comprising a cloud storage configured to store the result set and an input driver set corresponding to the batch processing request.

18. The computer system of claim 16, wherein the online graph database store is a production version used by an information sharing service, and wherein the offline graph database store is periodically mirrored from the online graph database store such that the offline graph database store includes the same content as the online graph database store, but with a latency delay.

19. The computer system of claim 16, wherein the offline graph database store includes at least 100 million nodes, and is permitted to have increased latency queries relative to latency queries permitted for the online graph database store.

20. The computer system of claim 16, wherein the computer system is operable to perform offline graph database store queries that include a greater number of hops than are permitted when using the online graph database store.
